(19) United States
(12) Patent Application Publication
(10) Pub. No.: US 2008/0178127 A1
(43) Pub. Date: Jul. 24, 2008

(54) Silicon Multiple Core or Redundant Unit Optimization Tool

(76) Inventors: Thomas J Dewkett, Staatsburg, NY (US); Joanne Ferris, Essex, VT (US); Raymond J. Rosner, Colchester, VT (US); Michael J. Shapiro, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/624,868

(22) Filed: Jan. 19, 2007

(51) Int. Cl. G06F 17/50

(52) U.S. Cl. 716/2

(57) ABSTRACT

A tool is provided that determines an optimal number of processor cores or other redundant units in a multiple core processor or system on a chip, along with selecting an associated semiconductor technology and integrated circuit package. The tool integrates design elements, performance and power metrics, manufacturing yields, redundancy, and costs that are both dependent and independent of design features, integrated circuit volume distributions, and boundary conditions, all for a variety of semiconductor technologies and packages. The tool may determine an optimal number of cores for a multiple core processor based on minimizing cost per unit performance or power or redundancy, or other designated design metric, and an associated volume distribution in each technology selected for manufacturing.

### BACKGROUND

1. Technical Field

The present application relates generally to design and fabrication of multiple core or redundant unit systems on a chip. More specifically, the present application is directed to silicon multiple core or redundant unit optimization tool.

2. Description of Related Art

The industry's rapid pursuit of multiple core processors signals the beginning of a new objective to improve performance by optimally maximizing the number of processing cores per chip. While current designs implement single and dual core processors, forthcoming designs may implement many more cores per chip as technology ground rules continue to shrink and power constraints are realized.

As the number of cores increases, performance, power, and cost will also increase, but at different rates depending on the processor design and technology used. An important metric of multiple core optimization is cost per unit of performance, or, more broadly, cost per unit design metric, e.g., transaction processing performance metrics, power, power/performance metrics, etc.

Overall product manufacturing cost is a function of integrated circuit (IC) design, semiconductor technology, yield, packaging, and production volume schedules. Performance, power, and other electrical metrics are functions of design, semiconductor technology, and packaging. Minimizing IC cost per unit design metric gives the design team guidance in terms of selecting the number of processor cores, silicon technology, and packaging that will provide a competitive product in the marketplace yielding the greatest cost efficiency per unit design metric.

Current multiple core processor design focuses primarily on determining the number of cores that optimize performance for a given power window. Often, cost is of secondary importance. There are methods and tools that calculate each of the individual components: IC cost, performance, power, and packaging for a given product design. However, there is not a methodology that integrates a range of design, semiconductor technologies, and packaging and identifies an optimal number of cores (redundancy) based on the most efficient cost per unit performance/power.

For example, an architect may want to design a sixteen-core multiple processor chip. How many cores should be put on the chip to make the lowest cost design, 16, 17, or 18? Because of yield considerations and redundancy, the answer is not obvious. For example, if the architect designs the chip with sixteen cores for a sixteen-core multiple processor chip, every chip for which a core fails will fail as a whole. Failed chips result in added cost. However, fabricating a chip with eighteen cores also increases cost. On the other hand, should the design use fourteen cores instead of sixteen due to power limitations? Normally, the answers to these questions must be derived individually.

### SUMMARY

The illustrative embodiments recognize the disadvantages of the prior art and provide a tool that determines an optimal number of processor cores or other redundant units in a multiple core processor or system on a chip, along with selecting an associated semiconductor technology and integrated circuit package. The tool integrates design elements, performance and power metrics, manufacturing yields, redundancy, and costs that are both dependent and independent of design features, integrated circuit volume distributions, and boundary conditions, all for a variety of semiconductor technologies and packages. The tool may determine an optimal number of cores for a multiple core processor, or the number of redundant elements on a system on a chip, based on minimizing cost per unit performance or power, or other designated design metric, and an associated volume distribution in each technology selected for manufacturing.

In one illustrative embodiment, a method is provided in a data processing system for optimization of multiple core chip design. The method comprises defining a chip design, breaking the chip design into a plurality of core entities, calculating the circuits in each of the plurality of core entities, automatically building multiple design cases with combinations of core entities, automatically determining a yield for each design case, and selecting a design case with a best yield.

In one exemplary embodiment, determining a yield for each design case comprises determining a number of chip sites per wafer for each design case and multiplying the number of chip sites per wafer by the yield to determine a good chips per wafer value for each design case. In a further exemplary embodiment, selecting a design case with a best yield comprises selecting a design case with a best good chips per wafer value. In another exemplary embodiment, the chip design has N core entities, and building multiple design cases comprises building design cases with zero to N core entities.

In another exemplary embodiment, determining a yield for each design case comprises determining a probe yield for a given design case determining a module yield for the given design case determining a core-independent silicon cost for the given design case, and determining a silicon die cost for the given design case based on the probe yield, the module yield, and the core-independent silicon cost for the given design case.

In a further exemplary embodiment, determining a yield for each design case comprises determining a probe yield for a given design case, determining a module yield for the given design case, determining a core-independent probe cost for the given design case, and determining a probe cost for the given design case based on the probe yield, the module yield, and the core-independent probe cost for the given design case.

In a still further exemplary embodiment, determining a yield for each design case comprises determining a module yield for the given design case, determining a core-independent substrate cost for the given design case, and determining a substrate cost for the given design case based on the probe yield, the module yield, and the core-independent substrate cost for the given design case.

In yet another exemplary embodiment, determining a yield for each design case comprises determining a module yield for the given design case, determining a core-independent bond and assembly cost for the given design case, and determining a bond and assembly cost for the given design case based on the probe yield, the module yield, and the core-independent bond and assembly cost for the given design case.

In another exemplary embodiment, determining a yield for each design case comprises determining a module yield for the given design case, determining a core-independent module test cost for the given design case, and determining a module test cost for the given design case based on the probe yield, the module yield, and the core-independent module test cost for the given design case.

In a further exemplary embodiment, determining a yield for each design case comprises receiving a performance/core ratio, determining a performance for each design case, determining a cost/performance ratio for each design case, and selecting a design case with a minimum cost/performance ratio based on a demand schedule and boundary conditions.

In another illustrative embodiment, a system is provided for optimization of multiple core chip design. The system comprises a processor and a memory coupled to the processor. The memory comprises instructions which, when executed by the processor, cause the processor to define a chip design, break the chip design into a plurality of core entities, calculate the circuits in each of the plurality of core entities, automatically build multiple design cases with combinations of core entities, automatically determine a yield for each design case, and select a design case with a best yield.

In other exemplary embodiments, the instructions cause the processor to perform various ones, and combinations of, the operations outlined above with regard to the method illustrative embodiment.

In a further illustrative embodiment, a computer program product is provided in a computer readable medium. The computer program product comprises a computer readable program which, when executed by a computing device, causes the computing device to define a chip design, break the chip design into a plurality of core entities, calculate the circuits in each of the plurality of core entities, automatically build multiple design cases with combinations of core entities, automatically determine a yield for each design case, and select a design case with a best yield.

In other exemplary embodiments, the computer readable program, when executed on a computing device, causes the computing device to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a pictorial representation of a data processing system in which aspects of the illustrative embodiments may be implemented;

FIG. 2 is a block diagram of an exemplary data processing system in which aspects of the illustrative embodiments may be implemented;

FIG. 3 is a flowchart illustrating operation of determining chip yield for various separate chip designs;

FIG. 4 is a flowchart illustrating operation of an optimization tool determining yield for each chip design in accordance with an illustrative embodiment;

FIG. 5 is a flowchart illustrating operation of an optimization tool with a partial good calculator in accordance with an illustrative embodiment; and

FIG. 6 is a flowchart illustrating cost minimization in an optimization tool in accordance with an illustrative embodiment.

### DETAILED DESCRIPTION OF THE ILLUSTRATIVE EMBODIMENTS

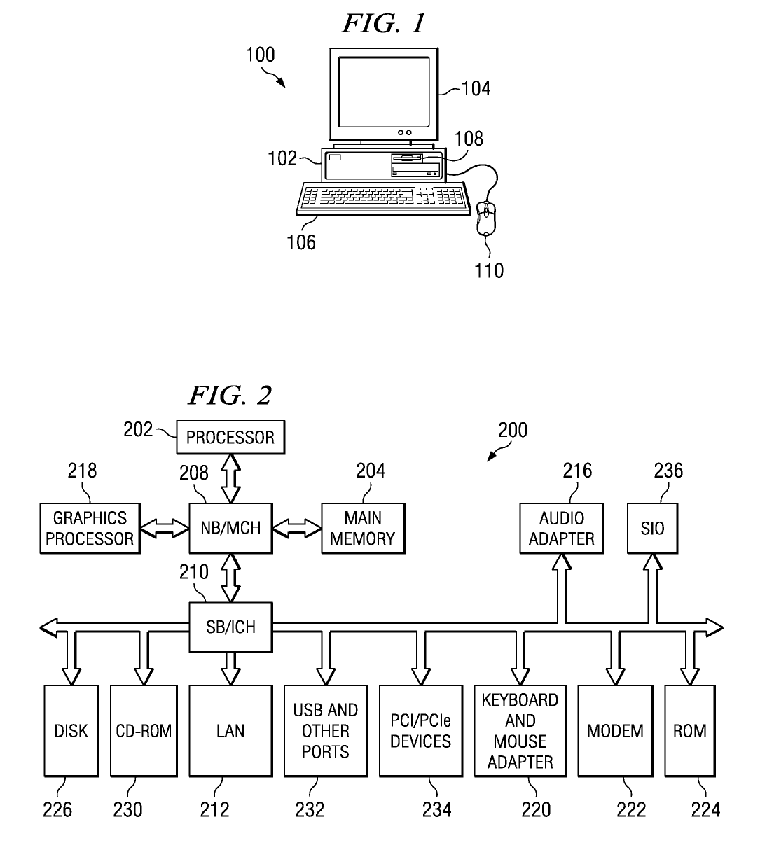

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is a pictorial representation of a data processing system in which aspects of the illustrative embodiments may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer™ computer or IntelliStation® computer, which are products of International Business Machines Corporation, located in Armonk, N.Y.

Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of an exemplary data processing system is shown in which aspects of the illustrative embodiments may be implemented. Data processing system 200 is an example of a computer, such as computer 100 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIG. 1-2 may vary depending on the implementation. Other internal hardware or peripheral devices, such as flash memory, equivalent non-volatile memory, or optical disk drives and the like, may be used in addition to or in place of the hardware depicted in FIG. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

In accordance with an illustrative embodiment, a redundant unit optimization tool determines an optimum number of processor cores or other redundant units on a specific multiple core processor or system-on-a-chip design. As used herein, a “core” may be a processor core or any other redundant functional unit. The optimization tool receives as input a single core design description in terms of the number of circuits and area, additional circuitry that is a multiple of the number of cores, and core-independent circuitry, all for a given semiconductor technology. The tool determines the performance and power as a function of the number of cores per design. In one exemplary embodiment, the tool redefines the single core description as the repetitive, scaleable, or functional equivalent single design unit.

The optimization tool calculates the yield as a function of the number of cores, time, and technology using industry equations and assumptions, as needed. The optimization tool also calculates the chips per wafer as a function of the number of cores and technology using common industry equations. Furthermore, the tool determines design-independent processed semiconductor wafer cost as a function of technology and time, and design-dependent processed semiconductor wafer cost as a function of technology, time, and the number of cores.

In addition, the optimization tool determines design-independent test cost, as well as design-dependent test cost as a function of the number of cores. Furthermore, the tool determines design-dependent bond and assembly, package costs as a function of the number of cores, as well as design-independent bond and assembly, package costs. Still further, the tool receives as input product volume assumptions and constraints as a function of time.

The optimization tool manipulates these inputs using mathematical optimization techniques to identify the optimum number of cores for the multiple core processor or system-on-a-chip and the associated manufacturing volume in each technology and package that provides minimum cost per unit performance and/or power.

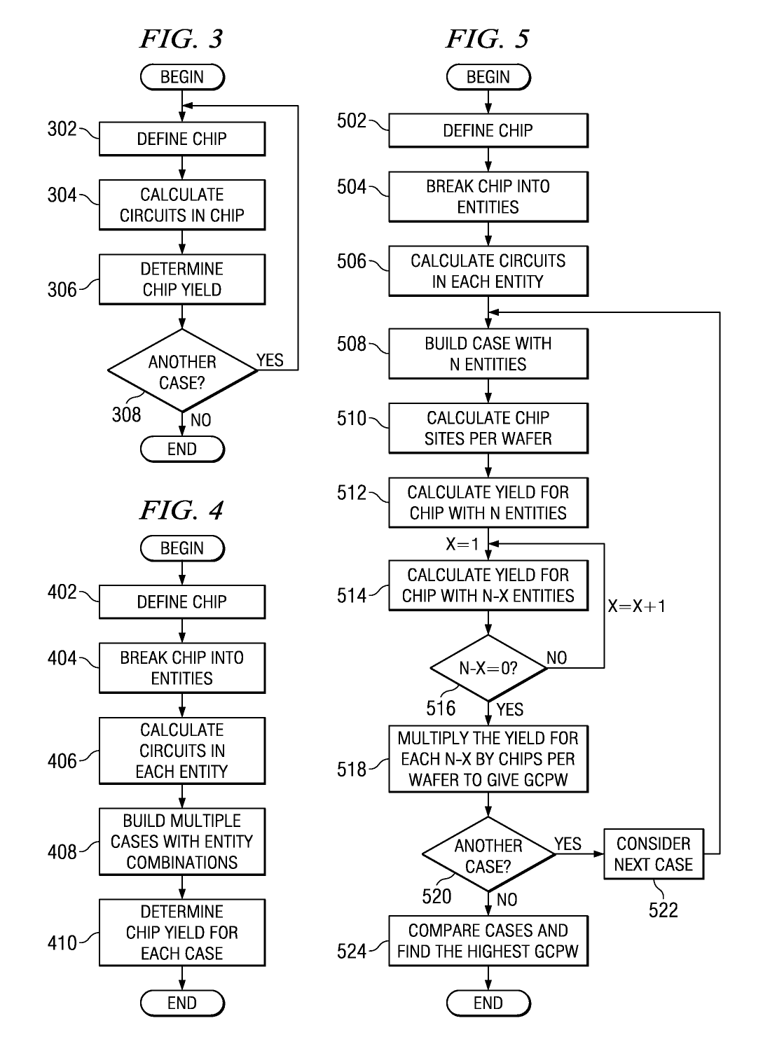

In accordance with the illustrative embodiment, the chip design is “disassembled” into parts to calculate yields with different combinations of the parts. The prior art solutions, however, treat these different combinations as separate chip designs and calculates yields from scratch for each different design. FIG. 3 is a flowchart illustrating operation of determining chip yield for various separate chip designs. Operation begins, and the designer, perhaps using a tool, defines a chip design (block 302). The designer then calculates circuits in the chip (block 304) and determines chip yield for the chip design (block 306). In block 304, the designer may calculate the circuits in the chip and/or the area in the chip. While calculating the circuits may be preferred for calculating yield, the industry typically calculates area. Therefore, in an alternative embodiment, the designer may calculate area in block 304. The designer then determines whether to calculate yield for another case (block 308). If the designer decides to calculate yield for another case, operation returns to block 302 to define another chip design; otherwise, operation ends.

Thus, in the prior art, the designer must manually consider every combination of cores, technology, and packaging. The designer must then calculate chip yield, as well as power, performance, and other parameters from scratch for each design.

FIG. 4 is a flowchart illustrating operation of an optimization tool determining yield for each chip design in accordance with an illustrative embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

With reference to FIG. 4, operation begins, and the chip designer defines the chip design (block 402). The chip designer may provide the chip design as input or may design the chip within the optimization tool. For example, the optimization tool of the illustrative embodiments may be integrated within, or a plug-in for, a semiconductor or integrated circuit development tool.

Next, the optimization tool breaks the chip design into entities (block 404) and calculates the circuits (and/or area) in each entity (block 406). The tool breaks the chip apart into redundant units. Each redundant unit is defined as a single entity. The tool calculates a normalized logic circuit count for the entity even if it contains eDRAM, SRAM, analog, and/or other circuit types. Now, multiples of each entity can be “built” into any case the designer would like to examine with the tool. Once the entities are created, they can be converted into different technologies (e.g., 90 nm, 65 nm, or 45 nm). This allows the tool to resize the area of each entity. The entities can then be “built” into cases with different technology nodes.

Then, the optimization tool builds multiple cases with entity combinations (block 408). The tool then determines the chip yield for each case (block 410), and operation ends.

In accordance with exemplary aspects of the illustrative embodiments, a partial good calculator builds on the fact that the chip is broken into entities. In addition to generating different cases that have multiples of the entities, the optimization tool now can calculate the yield with redundant entities. For example, a particular system-on-a-chip may have eight processing cores. After the chip is built, the design team may decide that only eight processing cores have to work in order to get a good chip. The result is increased yield. Therefore, one of the processing cores is redundant and could substitute for a bad core. As the number of cores increases in designs, figuring out the number of redundant elements to design in a chip becomes less obvious. The partial good calculator answers this question.

FIG. 5 is a flowchart illustrating operation of an optimization tool with a partial good calculator in accordance with an illustrative embodiment. The partial good calculator determines the yield of all good chips with N of entity 1. In alternative embodiments, the partial good calculator can determine yields with entity 2, entity 3, entity 4, etc; however, for simplicity, the flowchart illustrated in FIG. 5 shows calculating the yield for only one type of entity. The partial good calculator then determines the yield of the chip with N−1 of entity 1 and so forth, until all of the cases have been calculated.

Operation begins, and the chip designer defines the chip design (block 502). The optimization tool breaks the chip into entities (block 504) and calculates the circuits in each entity (block 506). Then, the tool builds a case with N entities (block 508). The tool then calculates the number of chip sites per wafer (block 510) and calculates the yield for the chip with N entities (block 512).

Thereafter, for X=1, the optimization tool calculates the yield for a chip with N−X entities (block 514). The tool then determines whether N−X=0, meaning the chip design has no instances of the entity (block 516). If N−X does not equal zero, then the tool increments X and returns to block 514 to calculate the yield for a chip with N−X entities.

If N−X is equal to zero in block 516, the optimization tool multiplies the yield for each N−X by chips per wafer to give a good chips per wafer (gcpw) value (block 518). Then, the tool determines whether another case exists (block 520). Another case may be a different value for N or a different fabrication technology, for example. If there is another case, the tool considers the next case (block 522), and operation returns to block 508 to build a case with N entities. However, if another case does not exist in block 520, the tool compares the cases and finds the design with the case with the highest gcpw (block 524). Thereafter, operation ends.

With this information, the tool can calculate the yield of a chip with redundant entities. If there are sixteen cores on a chip, but the application only requires fourteen cores to function, then two of the cores are redundant. The tool may then determine the resulting yield while at the same time realizing that the chip area is driven by sixteen cores. To determine which solution is the optimum case, the tool multiplies the yield by the chip sites per wafer to come up with the number of good chips per wafer. In this example, the algorithm may start by calculating the chip sites per wafer for sixteen good cores, fifteen good cores, fourteen, and so on down to zero good cores. Then, the tool may compare this solution to one with seventeen cores and one with fifteen cores to see if one redundant core is better than two or three, for example.

In order to minimize the end cost of a chip when considering different technologies, the optimization tool may calculate an intermediate cost by year for each technology, which is independent of any specific case. For each case, the intermediate cost for each technology is then combined with the design specific cost. The tool may then compare the costs of the various technologies for all the cases and find a minimum cost. For example, a chip can be designed in various technologies (90 nm, 65 nm, or 45 nm). The tool may then find the minimum cost for each case by technology by year. It may show that a chip build in 65 nm is the best solution in 2008 and 2009, but in 2010, the same design would be cheaper in 45 nm technology. In the prior art, each case would have to be calculated manually in each specific technology. Then, all the specific results would need to be compared manually.

Chip costs (e.g., raw wafer, processing, terminal metals, dice/sort/pick, etc.) and wafer test cost are dependent on the number of cores per die. A cost intermediate quantifying the design-independent portion of cost is determined and placed in an output file for subsequent manipulation. This is later combined with the design-dependent portion of cost for each case. In this way, the tool may find the minimum chip cost across a wide variety of cases.

In one exemplary embodiment, the tested die cost may be calculated as follows:

TestedDieCost=[*(silicon_costs)+electrical_test_cost]/gcpw

which may be shown as:

TestedDieCost=*silicon_costs/gcpw+electrical_test_cost/gcpw

A good chips per wafer value may be calculated as follows:

gcpw=chips_per_wafer·process_yields·electrical_test_yields,

where process yields are the product of the yields at various stages of processing, i.e. wafer processing, terminal metals, dice/sort/pick, etc.

As both the chips per wafer and the electrical test yield are dependent on the chip design, the silicon cost intermediate may be defined as follows:

intermediate_cost=*(silicon_costs)/process_yields,

where process yield is fixed for a specific technology or may be defined as a function of time. For example, every part manufactured in a given 65 nm technology has the same *(silicon_costs)/process yields. And, every part in 45 nm has the same *(silicon_costs)/process_yields. The electrical test cost intermediate is calculated in a similar manner, calculating the portion that is independent of the design. Again, this is calculated for each technology.

Because chips are broken up into entities, the entities are combined in different configurations and in the end, a good chips per wafer value is calculated for each combination. These results may then be combined with the intermediate costs to determine the optimum technology by year.

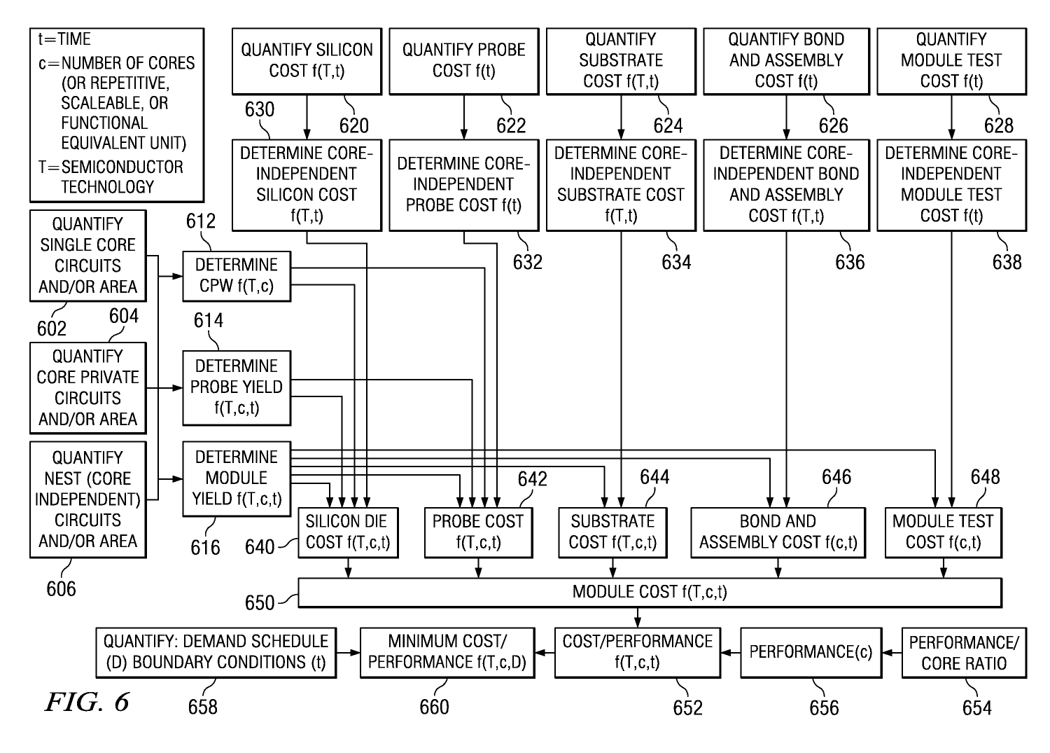

FIG. 6 is a flowchart illustrating cost minimization in an optimization tool in accordance with an illustrative embodiment. The optimization tool quantifies single core circuits (block 602), core private circuits and/or area (block 604), and nest (core independent) circuits and/or area (block 606). Given these, the optimization tool determines chips per wafer, which is a function of technology and the number of cores (block 612), probe yield, which is a function of technology, the number of cores, and time (block 614), and module yield, which is a function of technology, the number of cores, and time (block 616).

The optimization tool also quantifies silicon cost, which is a function of technology and time (block 620). Given silicon cost, the optimization tool determines core-independent silicon cost, which is a function of technology and time (block 630). The tool also quantifies probe cost, which is a function of time (block 622). Given probe cost, the tool determines core-independent probe cost, which is a function of time (block 632). In addition, the optimization tool quantifies substrate cost, which is a function of technology and time (block 624). Given substrate cost, the tool determines core-independent substrate cost, which is a function of technology and time (block 634). The optimization tool also quantifies bond and assembly cost, which is a function of time (block 626). Given bond and assembly cost, the tool determines core-independent bond and assembly cost, which is a function of technology and time (block 636). Further, the optimization tool quantifies module test cost, which is a function of time (block 628). Given module test cost, the tool determines core-independent module test cost, which is a function of time (block 638).

Thus, the chips per wafer (block 612), probe yield (block 614), and module yield (block 616) are dependent on the number of cores. The silicon cost (block 630), probe cost (block 632), substrate cost (block 634), bond and assembly cost (block 636), and module test cost (block 638) contain core-independent costs.

For each case, the optimization tool uses the chips per wafer (block 612), probe yield (block 614), module yield (block 616), and core-independent silicon cost (block 630) to determine a silicon die cost for the design (block 640), which is a function of technology, the number of cores, and time. The optimization tool also uses the chips per wafer (block 612), probe yield (block 614), module yield (block 616), and core-independent probe cost (block 632) to determine probe cost for each case (block 642), which is a function of technology, the number of cores, and time. The optimization tool uses module yield (block 616) and core-independent substrate cost (block 634) to determine substrate cost for each individual case (block 644), which is a function of technology, the number of cores, and time. Furthermore, the tool uses module yield (block 616) and core-independent bond and assembly cost (block 636) to determine bond and assembly cost for the design in each case (block 646), which is a function of the number of cores and time. The tool also uses module yield (block 616) and core-independent module test cost (block 638) to determine module test cost for each case (block 648), which is a function of the number of cores and time.

Then, the optimization tool uses the silicon die cost (block 640), probe cost (block 642), substrate cost (block 644), bond and assembly cost (block 646), and module test cost (block 648) for each case to determine a module cost (block 650), which is a function of technology, number of cores, and time. In addition, the tool uses a performance/core ratio (block 654) (or other design metric) to determine performance for the design case as a function of the number of cores (block 656). Given the module cost for each design case (block 650) and the performance (block 656), the optimization tool determines a cost/performance ratio for each design case (block 652), which is a function of technology, number of cores, and time.

The optimization tool may also quantify a fab-demand schedule and boundary conditions for each design case (block 658). Given the IC demand schedule and boundary conditions from block 658 and the cost/performance ratio from block 652, the optimization tool determines a case with minimum cost/performance as a function of technology, number of cores, and demand schedule (block 660).

Thus, the illustrative embodiments solve the disadvantages of the prior art by providing a tool that determines an optimal number of processor cores or other redundant units in a multiple core processor or system on a chip, along with selecting an associated semiconductor technology and integrated circuit package. The tool integrates design elements, performance and power metrics, manufacturing yields, redundancy, and costs that are both dependent and independent of design features, integrated circuit volume distributions, and boundary conditions, all for a variety of semiconductor technologies and packages. The tool may determine an optimal number of cores for a multiple core processor based on minimizing cost per unit performance or power or redundancy, or other designated design metric, and an associated volume distribution in each technology selected for manufacturing.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for optimization of multiple core chip design, the method comprising:
defining a chip design;
breaking the chip design into a plurality of core entities;
calculating the circuits in each of the plurality of core entities;
automatically building multiple design cases with combinations of core entities;
automatically determining a yield for each design case; and
selecting a design case with a best yield.

2. The method of claim 1, wherein determining a yield for each design case comprises:
determining a number of chip sites per wafer for each design case; and
multiplying the number of chip sites per wafer by the yield to determine a good chips per wafer value for each design case.

3. The method of claim 2, wherein selecting a design case with a best yield comprises selecting a design case with a best good chips per wafer value.

4. The method of claim 2, wherein the chip design has N core entities, wherein building multiple design cases comprises building design cases with zero to N core entities.

5. The method of claim 1, wherein determining a yield for each design case comprises:
determining a probe yield for a given design case;
determining a module yield for the given design case;
determining a core-independent silicon cost for the given design case; and
determining a silicon die cost for the given design case based on the probe yield, the module yield, and the core-independent silicon cost for the given design case.

6. The method of claim 1, wherein determining a yield for each design case comprises:
determining a probe yield for a given design case;
determining a module yield for the given design case;
determining a core-independent probe cost for the given design case; and
determining a probe cost for the given design case based on the probe yield, the module yield, and the core-independent probe cost for the given design case.

7. The method of claim 1, wherein determining a yield for each design case comprises:
determining a module yield for the given design case;
determining a core-independent substrate cost for the given design case; and
determining a substrate cost for the given design case based on the probe yield, the module yield, and the core-independent substrate cost for the given design case.

8. The method of claim 1, wherein determining a yield for each design case comprises:
determining a module yield for the given design case;
determining a core-independent bond and assembly cost for the given design case; and
determining a bond and assembly cost for the given design case based on the probe yield, the module yield, and the core-independent bond and assembly cost for the given design case.

9. The method of claim 1, wherein determining a yield for each design case comprises:
determining a module yield for the given design case;
determining a core-independent module test cost for the given design case; and
determining a module test cost for the given design case based on the probe yield, the module yield, and the core-independent module test cost for the given design case.

10. The method of claim 1, wherein determining a yield for each design case comprises:
receiving a performance/core ratio;
determining a performance for each design case;
determining a cost/performance ratio for each design case; and
selecting a design case with a minimum cost/performance ratio based on a demand schedule and boundary conditions.

11. A system for optimization of multiple core chip design, comprising:
a processor; and
a memory coupled to the processor, the memory comprising instructions which, when executed by the processor, cause the processor to:
define a chip design;
break the chip design into a plurality of core entities;
calculate the circuits in each of the plurality of core entities;
automatically build multiple design cases with combinations of core entities;
automatically determine a yield for each design case; and
select a design case with a best yield.

12. The system of claim 11, wherein determining a yield for each design case comprises:
determining a number of chip sites per wafer for each design case; and
multiplying the number of chip sites per wafer by the yield to determine a good chips per wafer value for each design case.

13. The system of claim 12, wherein selecting a design case with a best yield comprises selecting a design case with a best good chips per wafer value.

14. The system of claim 12, wherein the chip design has N core entities, wherein building multiple design cases comprises building design cases with zero to N core entities.

15. The system of claim 11, wherein determining a yield for each design case comprises:
receiving a performance/core ratio;
determining a performance for each design case;
determining a cost/performance ratio for each design case; and
selecting a design case with a minimum cost/performance ratio based on a demand schedule and boundary conditions.

16. A computer program product in a computer readable medium, the computer program product comprising a computer readable program which, when executed by a computing device, causes the computing device to:
define a chip design;
break the chip design into a plurality of core entities;
calculate the circuits in each of the plurality of core entities;
automatically build multiple design cases with combinations of core entities;
automatically determine a yield for each design case; and
select a design case with a best yield.

17. The computer program product of claim 16, wherein determining a yield for each design case comprises:
determining a number of chip sites per wafer for each design case; and
multiplying the number of chip sites per wafer by the yield to determine a good chips per wafer value for each design case.

18. The computer program product of claim 17, wherein selecting a design case with a best yield comprises selecting a design case with a best good chips per wafer value.

19. The computer program product of claim 17, wherein the chip design has N core entities, wherein building multiple design cases comprises building design cases with zero to N core entities.

20. The computer program product of claim 16, wherein determining a yield for each design case comprises:
receiving a performance/core ratio;
determining a performance for each design case;
determining a cost/performance ratio for each design case; and
selecting a design case with a minimum cost/performance ratio based on a demand schedule and boundary conditions.
